(19) United States
(12) Patent Application Publication
(10) Pub. No.: US 2021/0218748 A1
(43) Pub. Date: Jul. 15, 2021

(54) METHOD AND SYSTEM FOR DEFINING ROLES IN AN IDENTITY AND ACCESS MANAGEMENT SYSTEM

(71) Applicant: ELEMENT AI Inc., MONTREAL (CA)

(72) Inventors: Louis Philip MORIN, MONTREAL (CA); Benoit HAMELIN, MONTREAL (CA); Fanny LALONDE LEVESQUE, MONTREAL (CA); Nicolas BIGAOUETTE, MONTREAL (CA); Frederic MICHAUD, MONTREAL (CA); Eric GINGRAS, MONTREAL (CA); Jean-Christophe TESTUD, MONTREAL (CA); Etienne MARCOTTE, MONTREAL (CA); Patrick ST-LOUIS, MONTREAL (CA)

(21) Appl. No.: 17/054,244

(22) PCT Filed: May 10, 2019
(86) PCT No.: PCT/IB2019/053897

§ 371 Date: Nov. 10, 2020

Related U.S. Application Data
(60) Provisional application No. 62/669,591, filed on May 10, 2018.

(51) Int. Cl. H04L 29/06

(52) U.S. Cl. CPC H04L 63/102; H04L 63/20; H04L 63/104

(57) ABSTRACT

A computer-implemented method for defining roles, comprising: receiving access usage data comprising identities and respective performed actions; receiving a list of entitlements each allowing the execution of at least one respective action; generating a plurality of groups of actions by regrouping given ones of the identities having associated thereto a same group of the respective performed actions using the access usage data; for each one of the plurality of groups of actions, determining a group of entitlements contained in the list of entitlements that allow the execution of the group of actions; for each one of the plurality of groups of actions, associating thereto the respective group of entitlements, thereby obtaining a plurality of roles; and outputting the plurality of roles.

### TECHNICAL FIELD

The present invention relates to the field of Identity and Access Management (IAM), and more particularly to methods and system for defining roles in an IAM system.

### BACKGROUND

In IAM, a role is an aggregation of entitlements, privileges or access rights that allow authentication and authorization to perform at least one specific action in an application, system or site. The roles thus constructed are then assigned to users to give them all associated accesses in a single act of association instead of having to grant each individual access one by one. Roles may also have an associated rule, based on human resources (HR) attribute values, that define groups of users who automatically receive the role and who lose the role when they no longer fit the rule. This access granting model, called Role Based Access Control (RBAC) allows for operationalization of complex access control models, which can then be used to automate large parts of access provisioning and deprovisioning. They are useful when they can streamline the granting of large amounts of accesses because of a large number of accesses a specific role requires, because they are used by a large number of identities, or because there is a high employee turnover in a job that can be covered by a role, for example.

Defining roles may be a complex task. In a RBAC model, role mining is the activity of creating roles based on patterns found in existing access rights. These patterns require very high efforts to find, due to noise in data. Current usual tools offer mathematical variables that can be tweaked to help in the role mining, but generally require a mathematical background that a user of an IAM system usually does not have.

The noise in data takes the form of access rights that people do not actually need or even use. This noise can be very high in applications with a long history of usage because of unchecked accumulation of rights, faulty security models in applications or access request errors. This means there is generally an heavy effort consuming clean-up activity before role mining occurs.

Furthermore, once created, a role requires changes as the function that it represents may evolve in time. New applications may be added, old applications may be removed, organizations may reorganize their departments and change functions of employees, etc. Roles made to represent access needs of functions impacted then require to be merged, split, entitlements added or removed, etc. Overall, roles require effort to create before having a return on investment, and once done, require more maintenance effort if the organization undergoes many changes

Some current methods entail doing a thorough clean-up of access rights to reduce the noise before performing role mining. This may take one to two years in some instances, and even then it may reduce the noise only partially. This is due to the large amounts of entitlements that people have, combined with a lack of knowledge around which actions are allowed by entitlements. In doubt, a manager usually lets an employee keep an access if he does not know if the employee actually needs the entitlement. In turn, this becomes a cybersecurity risk in that unused accesses should be limited.

Other current methods may also create roles based purely on business knowledge with no role mining. Such a method is usually time-consuming and generates limited roles since IAM managers are usually unsure what specific entitlements should be added to users since they have no data to back their decision other than their experience. Such methods usually require more people to be involved to validate the role.

Therefore, there is a need for an improved method and system for defining roles.

### SUMMARY

According to a first broad aspect, there is provided a computer-implemented method for defining roles, comprising: receiving access usage data comprising identities and respective performed actions; receiving a list of entitlements each allowing the execution of at least one respective action; generating a plurality of groups of actions by regrouping given ones of the identities having associated thereto a same group of the respective performed actions using the access usage data; for each one of the plurality of groups of actions, determining a group of entitlements contained in the list of entitlements that allow the execution of the group of actions; for each one of the plurality of groups of actions, associating thereto the respective group of entitlements, thereby obtaining a plurality of roles; and outputting the plurality of roles.

In one embodiment, said receiving access usage data comprises receiving account identifications (IDs) and the respective performed actions;

In one embodiment, the method further comprises receiving application data comprising respective actual entitlements associated with the account IDs.

In one embodiment, said receiving a list of entitlements comprises generating a map of entitlements by mapping the entitlements to the performed actions using the access usage data and the application data.

In one embodiment, said mapping the entitlements to the performed actions is performed by solving a linear program in binary variables.

In one embodiment, the method further comprises receiving attribute data comprising user IDs and respective human resources and business attributes.

In one embodiment, the method further comprises mapping the account IDs to the user IDs.

In one embodiment, said generating the plurality of groups of actions is performed using further the attribute data.

In one embodiment, said generating the plurality of groups of actions is performed using at least one of a clustering method, a matrix decomposition method, a topic modeling method, a coverage maximization method and an association rule mining method to obtain a probabilistic assignment of actions to the groups of actions.

In one embodiment, the clustering method comprises one of a Density-Based Spatial Clustering of Applications with Noise (DBSCAN) method, a K-means method and a Hierarchical Clustering method.

In one embodiment, the matrix decomposition method comprises one of a Multiplicative Weights Update method and a Projected Gradient method.

In one embodiment, the topic modeling method comprises one of a Latent Dirichlet Allocation (LDA) method and a Hierarchical Dirichlet Process (HDP) method.

In one embodiment, the coverage maximization method comprises of a Maximal Biclique method.

In one embodiment, the association rule mining method comprises one of an Apriori method, a Frequent Pattern (FP)-Growth method and an Eclat method.

In one embodiment, the method further comprises using a discretization procedure to convert the probabilistic assignment of actions to the groups of actions to an actual assignment of actions to the groups of actions.

In one embodiment, the method further comprises assigning at least one of the respective human resources and business attributes to each one of the groups of actions, thereby obtaining an assignment of attributes for each group of actions.

In one embodiment, said determining a group of entitlements is performed using the application data, the actual assignment of actions to the groups of actions and the assignment of attributes for each group of actions.

According to another broad aspect, there is provided a computer program product comprising a non-volatile computer readable memory storing computer executable instructions thereon that when executed by a computer perform the steps of the above-described method.

According to a further broad aspect, there is provided a system comprising a processor, a communication unit and a memory having stored thereon executable instructions that when executed by the processor perform the steps of the above-described method.

According to still another broad aspect, there is provided a system comprising a group generating unit for receiving access usage data comprising identities and respective performed actions, and generating a plurality of groups of actions by regrouping given ones of the identities having associated thereto a same group of the respective performed actions using the access usage data; and a role generating unit for: receiving a list of entitlements each allowing the execution of at least one respective action, for each one of the plurality of groups of actions, determining a group of entitlements contained in the list of entitlements that allow the execution of the group of actions; for each one of the plurality of groups of actions, associating thereto the respective group of entitlements, thereby obtaining a plurality of roles; and outputting the plurality of roles.

In one embodiment, the access usage data comprises account identifications (IDs) and the respective performed actions;

In one embodiment, at least one of the group generating unit and the role generating unit is further configured for receiving application data comprising respective actual entitlements associated with the account IDs.

In one embodiment, the role generating unit is further configured for generating a map of entitlements by mapping the entitlements to the performed actions using the access usage data and the application data.

In one embodiment, the role generating unit is configured for mapping the entitlements to the performed actions by solving a linear program in binary variables.

In one embodiment, at least one of the group generating unit and the role generating unit is further configured for receiving attribute data comprising user IDs and respective human resources and business attributes.

In one embodiment, at least one of the group generating unit and the role generating unit is further configured mapping the account IDs to the user IDs.

In one embodiment, the group generating unit is configured for generating the plurality of groups of actions further using the attribute data.

In one embodiment, the group generating unit is configured for generating the plurality of groups of actions using at least one of a clustering method, a matrix decomposition method, a topic modeling method, a coverage maximization method and an association rule mining method to obtain a probabilistic assignment of actions to the groups of actions.

In one embodiment, the clustering method comprises one of a Density-Based Spatial Clustering of Applications with Noise (DBSCAN) method, a K-means method and a Hierarchical Clustering method.

In one embodiment, the matrix decomposition method comprises one of a Multiplicative Weights Update method and a Projected Gradient method.

In one embodiment, the topic modeling method comprises one of a Latent Dirichlet Allocation (LDA) method and a Hierarchical Dirichlet Process (HDP) method.

In one embodiment, the coverage maximization method comprises a Maximal Biclique method.

In one embodiment, the association rule mining method comprises one of an Apriori method, a Frequent Pattern (FP)-Growth method and an Eclat method.

In one embodiment, the group generating unit is further configured for using a discretization procedure to convert the probabilistic assignment of actions to the groups of actions to an actual assignment of actions to the groups of actions.

In one embodiment, the role generating unit is configured for assigning at least one of the respective human resources and business attributes to each one of the groups of actions, thereby obtaining an assignment of attributes for each group of actions.

In one embodiment, the role generating unit is configured for determining the group of entitlements using the application data, the actual assignment of actions to the groups of actions and the assignment of attributes for each group of actions.

It should be understood that the entitlements may also include privileges, access rights, and/or the like.

### BRIEF DESCRIPTION OF THE DRAWINGS

Further features and advantages of the present invention will become apparent from the following detailed description, taken in combination with the appended drawings, in which:

FIG. 1 is a flow chart of a method for creating roles for an IAM system, in accordance with a first embodiment;

FIG. 2 is a flow chart of a method for creating roles for an IAM system, in accordance with a second embodiment;

FIG. 3 is a block diagram of a processing module adapted to execute at least some of the steps of the method of FIG. 2, in accordance with an embodiment; and

FIG. 4 is a block diagram of a system adapted to execute the method of FIG. 1, in accordance with an embodiment.

It will be noted that throughout the appended drawings, like features are identified by like reference numerals.

### DETAILED DESCRIPTION

In the following there is described a method and system for doing role mining based on actual access usage of users such as employees of an organization, rather than on access rights as usually done. This is achieved by taking into account access usage data, not usually collected by IAM systems, to better find entitlement need patterns for the users. The access usage data is mapped to the entitlements to generate the roles.

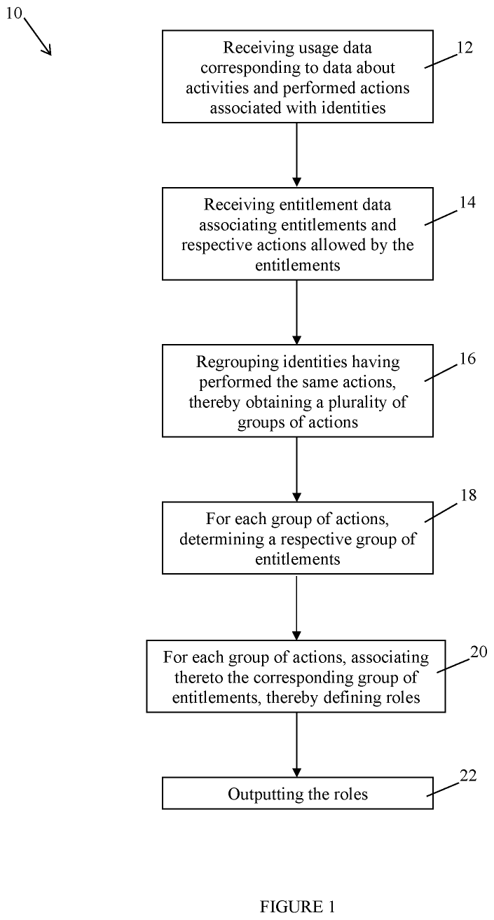

FIG. 1 illustrates a computer-implemented method 10 for defining roles in an IAM system. It should be understood that the method 10 is executed by a computer machine provided with at least one processor or processing unit, a memory or storing unit and communication means.

At step 12, access usage data are received for all of the users. Each user is identified by a respective identity. The access usage data describe all activities and actions performed by each identity over a given period of time. In one embodiment, the access usage data comprise data about any application, system or site that a user may access.

At step 14, entitlements data are received. The entitlements data comprises a list of entitlements and actions allowed by the entitlements. In one embodiment, an entitlement allows at least one action to be performed. In the same or another embodiment, more than one entitlement may be required to perform a single action.

In one embodiment, the list of entitlements received at step 14 comprises all possible entitlements created for any application, system or site that a user may access.

In one embodiment and as described below, the step 14 consists in generating the list of entitlements and respective actions.

At step 16, the access usage data received at step 12 are analyzed to regroup together the identities having performed the same actions. As a result, groups of identities are created and a respective group of same actions is associated with each group of entities to obtain a plurality of groups of actions. Each thus obtained group of actions may be seen as the first component of a respective role.

At step 18, a corresponding group of entitlements is associated to each group of actions determined at step 16, using the list of entitlements. Knowing the actions allowed by a given entitlement, a group of entitlements is generated by retrieving the given entitlements that allow the execution of all of the actions contained in a group of actions. Each thus obtained group of entitlements may be seen as the second component of a respective role.

At step 20, roles are created by associating the respective group of entitlements determined at step 18 to each group of actions determined at step 16.

At step 22, the roles defined at step 20 are outputted. In one embodiment, the roles are stored in memory. In the same or another embodiment, the roles may be transmitted to another computer machine such as an IAM system.

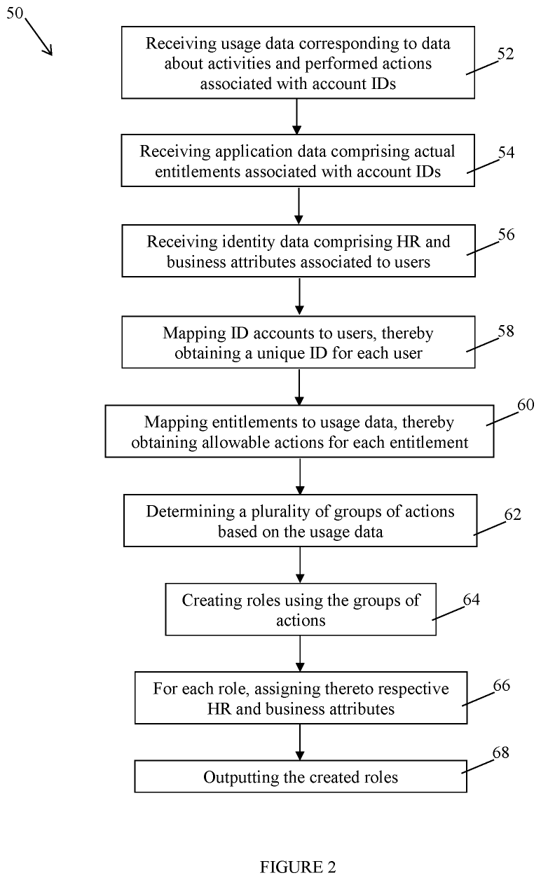

FIG. 2 illustrates a further embodiment of a computer-implemented method 50 for creating roles for an IAM system. Similarly to the method 10, it should be understood that the method 50 is to be executed by a computer machine.

At step 52, access usage data are received. The access usage data comprises a plurality of accounts identifications (IDs) and all activities and actions performed by each account ID while using any application, system or site that a user may use. In one embodiment, a user is provided with a single account ID. In another embodiment, more than one account ID may be assigned to a same user.

Adequate sources for collecting the access usage data may comprise STEM systems, directories, applications, and/or the like.

In one embodiment, the access usage data may comprise authentication and authorization activity to an applications, audit logs of activities or actions within an application, and/or the like.

At step 54, application data are received. The application data comprises actual entitlements associated to account IDs. It should be understood that the entitlements actually assigned to a given account ID may be inaccurate. For example, some of the entitlements assigned to a given account ID may provide access to the user of the account ID to applications that he does not need or he does not use or to applications that he should not be allowed to access.

In one embodiment, the application data may be collected by connecting to IAM systems, directories and/or applications.

At step 56, attribute data are received. For each user, the attribute data comprises respective attributes such as HR attributes and/or business attributes that may help identify a user's function within an organization. For example, the attribute data may comprise a title, a level, a manager's ID, an organization unit, a status, and/or the like.

In one embodiment, the attribute data is collected via systems such as IAM systems, HR systems, and/or the like.

At step 58, the account IDs are mapped to the users. For each user, at least one respective account ID is determined. When more than one account ID is associated to same user, the mapping of the account IDs to the users allows regrouping into a single user ID all of the account IDs associated to the user, and therefore all of the usage data associated to the user under different account IDs.

In one embodiment, the mapping of the account IDs to the users may be performed by accessing IAM systems, applications such as remote API, Remote procedure call (RPC), or the like.

In one embodiment, the user entity such as the name or the employee number of the users is first retrieved from the attribute data received at step 56. The user provided identities allow overwriting any discrepancy in the attribute data or the access usage data. The unique user accounts are gathered across all of the applications. If possible, the application accounts are extracted from the attribute data. The applications are then queried for identities of yet unmapped accounts (e.g. through API) and fuzzy matching of returned identities on the attribute data is performed. Fuzzy matching in attribute data of remaining accounts may then be performed. Unmapped accounts, if any, may be saved and/or displayed to be manually entered

At step 60, entitlements are mapped to the all possible performed actions received at step 52 using the access usage data and the application data. At step 60, it is determined the relationship between entitlements and performed actions, i.e. which respective entitlement(s) allows the execution of each performed action contained in the access usage data.

In one embodiment, the mapping of entitlements to actions is done by the resolution of a linear program over binary variables. A methodology to map as many pairs of which entitlements allow which actions contained in the access usage data may be performed.

In one embodiment, the mapping of the entitlements to actions is performed using the following method. The minimal-cost set of entitlements p* that enables all actions of given a is determined. Considering that binary vectors of {0, 1}n are embedded in R^{m}, p* may be expressed as

$${p}^{*} = \begin{matrix}arg {min}_{p ∈ {\{ 0 , 1 \}}^{m}} & {c}^{t} p \\ subject to & {P}^{t} p \geq a\end{matrix}$$

where:
a∈{0, 1}ⁿ is a binary vector that selects a subset of actions out of a set of n possible actions with aᵢ=1 if and only if the action i is enabled and aᵢ=0 otherwise;
p∈{0, 1}^{m} is a binary vector that selects a subset of entitlements out of a set of m possible entitlements with pⱼ=1 if and only if entitlement j is selected and pⱼ=0 otherwise;
p∈{0, 1}_{m×n′} is a binary matrix mapping entitlements to enabled actions with Pᵢⱼ=1 if and only if the entitlement i enables the action j, and Pᵢⱼ=0 otherwise; and
c∈R^{m} is a vector that sets the cost of granting each entitlement.

In one embodiment, if actions have not automatically been mapped to entitlements, a person such as a manager of the IAM system may manually map the remaining actions to entitlements.

At step 62, grouping of actions is performed. Users having performed the same actions are regrouped, thereby obtaining groups of users and a respective group of performed actions for each group of users.

In one embodiment, the determination of the groups of actions may be performed using a predefined machine learning algorithm using the usage access data and optionally the attribute data. In one embodiment, a clustering method, a matrix decomposition method, a topic modeling, a coverage maximization method and/or an association rule mining method may be used for regrouping actions. The input of these methods comprise the access usage data and optionally the attribute data. Examples of clustering methods include the DBSCAN method, the K-Means method, the Hierarchical clustering method, and the like. Examples of matrix decomposition methods include the Multiplicative Weight Update method, and the Projected Gradient method. Examples of topic modeling methods include the Latent Dirichlet Allocation (LDA) method, the Hierarchical Dirichlet Process (HDP) method, and the like. An example of coverage maximization method includes the Maximal Biclique method. Examples of association rule mining methods comprise the Apriori method, the FP-Growth method and the Eclat method. The output of these methods comprises groups of actions, i.e. a group-action assignment, and optionally a group-attribute assignment in the event that attribute data was provided as input.

In one embodiment, the group-action assignment previously performed may be considered as an identification of candidate actions to groups and the candidate actions have to be confirmed. In this case, the method 50 further comprises a step of determining whether the candidate action should be assigned to the group. Depending on the output of the method used for generating groups of candidate actions, the assignment of actions may be done by direct assignment, or by using a discretization procedure to convert the probabilistic assignment to a binary group-action assignment. The output is a confirmed group-action assignment, i.e. groups of users and a respective group of actions associated to each group of users.

At step 64, the roles are generated using the groups of actions determined at step 62 and the respective entitlements that allow the actions at step 60.

At step 66, respective HR and/or business attributes are assigned to each role determined at step 64. This may be done by using the group-attribute assignment determined in step 62, if outputted, or by using a predefined heuristic and/or machine learning algorithm. Examples of algorithms include association rule mining methods, or the like. The input of the algorithm comprises the attribute data and the group-action assignment determined at step 62. And the output is a group-attribute assignment, i.e. a group of HR and/or business attributes associated to each role. For each user, it is determined by their respective HR and/or business attributes values that are associated with the role if they are assigned or not to the role.

It should be understood that the step 66 may be omitted.

At step 68, the generated roles are outputted. In one embodiment, the roles may be stored in memory. In the same or another embodiment, the generated roles may be displayed on a display unit for approval for example.

In one embodiment, the generated roles may be displayed to an IAM analyst for example for approval. In one embodiment, a generated role may be displayed along with at least some of the following information:
an identification of the persons who should be included in the role;
the privileges that should be included in the role;
an identification of the new entitlements that were not assigned to the members of the group before the generation of the role; and/or
an evaluation of how much of the accesses of the members of the group are covered by the role

The IAM analyst is then asked to confirm the displayed role and may also modify the role. The IAM analyst may also input a name and/or a description for the role.

In order to help for the maintenance, the generated roles may be visible in the applications or the IAM system and a notification may be sent to the IAM analyst when a role is removed.

In one embodiment, when the system determines that the attribute data and/or access usage data has changed such as when new accesses are used, some accesses become unused or organization units have changed, a notification indicative of the change may be sent to the IAM analyst. The notification may also include proposed changes to the role in order to maintain the role coverage.

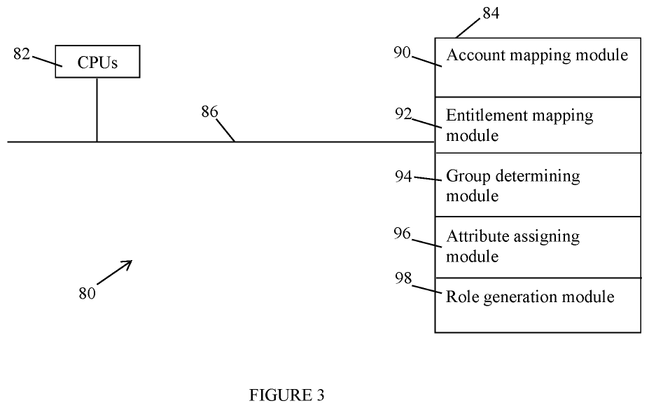

FIG. 3 is a block diagram illustrating an exemplary processing module 80 for executing the steps 52 to 68 of the method 50, in accordance with some embodiments. The processing module 80 typically includes one or more Computer Processing Units (CPUs) and/or Graphic Processing Units (GPUs) 82 for executing modules or programs and/or instructions stored in memory 84 and thereby performing processing operations, memory 84, and one or more communication buses 86 for interconnecting these components. The communication buses 86 optionally include circuitry (sometimes called a chipset) that interconnects and controls communications between system components. The memory 84 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 84 optionally includes one or more storage devices remotely located from the CPU(s) 82. The memory 84, or alternately the non-volatile memory device(s) within the memory 84, comprises a non-transitory computer readable storage medium. In some embodiments, the memory 84, or the computer readable storage medium of the memory 84 stores the following programs, modules, and data structures, or a subset thereof:
an account ID mapping module 90 for mapping account IDs to users;
an entitlement mapping module 92 for mapping entitlements to access usage data;
a group determining module 94 for regrouping users as a function of common performed actions;
an attribute assigning module 96 for assigning respective HR and/or business attributes to the groups of users; and
a role generation module 98 for generating roles and outputting the roles.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, the memory 84 may store a subset of the modules and data structures identified above. Furthermore, the memory 84 may store additional modules and data structures not described above.

Although it shows a processing module 80, FIG. 3 is intended more as functional description of the various features which may be present in a management module than as a structural schematic of the embodiments described herein. In practice, and as recognized by those of ordinary skill in the art, items shown separately could be combined and some items could be separated.

In one embodiment, the present method and system allow reducing the effort of finding patterns roles and accelerating the return on investment by adding data not prone to the noise of access rights, namely the actual access usage data. The present method and system allow for mapping access usage detail to access right automatically through the pattern itself with least common denominator access. The data volume for actual access usage (which is generated at every action) is important compared to access rights, which is semi-static. Therefore, more accurate results may be obtained. The present method and system allow automating many of the mathematical variables in role mining, thereby reducing the expertise required for IAM managers for example. In one embodiment, human error may be mitigated in access granting since the actual aces data are used for defining the roles, the present method and system offer a better picture of the entitlements associated with roles. Furthermore, maintenance of roles may be facilitated by automatically proposing changes to existing roles when access usage evolves far enough from the base role norm.

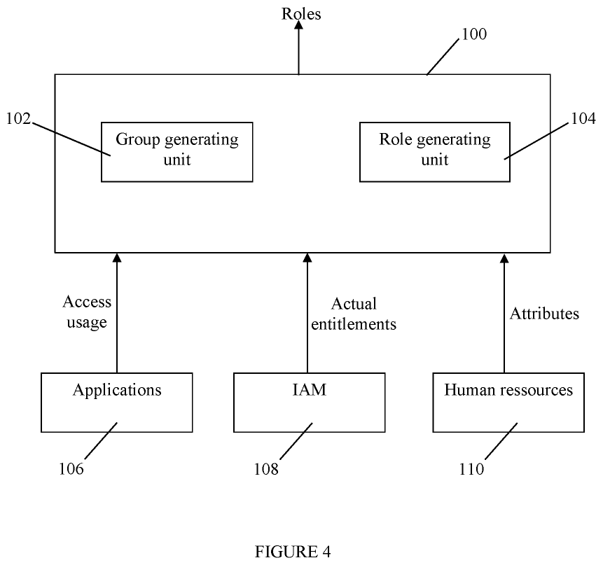

FIG. 4 illustrates one embodiment of a system 100 for generating roles. The system 100 comprises a group generating unit 102 and a role generating unit 106. The group generating unit 102 is configured for receiving access usage data comprising identities and respective performed actions, and generating a plurality of groups of actions by regrouping the identities having associated thereto the same performed actions using the access usage data received from applications 106, as described above.

The role generating unit 104 is configured for receiving from an IAM system 108 a list of entitlements each allowing the execution of at least one respective action and determining a group of entitlements contained in the list of entitlements that allow the execution of the group of actions generated by the group generating unit 102. The role generating unit 104 is further configured for associating a respective group of entitlements to each group of actions in order to generate the roles, and outputting the roles.

In one embodiment, the role generating unit is further configured for generating a map of entitlements by mapping the entitlements to the actions using the access usage data and the application data.

In one embodiment, the role generating unit is configured for mapping the entitlements to the performed actions by solving a linear program in binary variables.

In one embodiment, the system 100 is further configured for receiving attribute data comprising HR and/or business attributes from a HR system 110.

In one embodiment, the group generating unit 102 is configured for generating the plurality of groups of actions further using the attribute data.

It should be understood that the group generating unit 102 may use any of the above-described methods for generating the groups of actions.

In one embodiment, the role generating unit 104 is further configured for assigning at least one human resources and/or business attribute to each role.

It should be understood that the different data may be collected vis different ways. For example, access usage data can take the form of logs, diaries, databases, event stores, spreadsheets, APIS, etc. Privilege collections may be provided through APIs, spreadsheets, application documentation, etc. Attribute data may be provided through data files, databases, rolodexes, address books, contact stores, spreadsheets, etc.

It should be understood that any combination of methods for generating the groups of actions may used. When multiple methods are used, the results are computed from all of the used methods in parallel, and then reconciled for unicity.

The embodiments of the invention described above are intended to be exemplary only. The scope of the invention is therefore intended to be limited solely by the scope of the appended claims.

I/We claim:

1. A computer-implemented method for defining roles, comprising:
receiving access usage data comprising identities and respective performed actions;
receiving a list of entitlements each allowing the execution of at least one respective action;
generating a plurality of groups of actions by regrouping given ones of the identities having associated thereto a same group of the respective performed actions using the access usage data;
for each one of the plurality of groups of actions, determining a group of entitlements contained in the list of entitlements that allow the execution of the group of actions;
for each one of the plurality of groups of actions, associating thereto the respective group of entitlements, thereby obtaining a plurality of roles; and
outputting the plurality of roles.

2. The computer-implemented method of claim 1, wherein said receiving access usage data comprises receiving account identifications (IDs) and the respective performed actions;

3. The computer-implemented method of claim 2, further comprising receiving application data comprising respective actual entitlements associated with the account IDs.

4. The computer-implemented method of claim 3, wherein said receiving a list of entitlements comprises generating a map of entitlements by mapping the entitlements to the performed actions using the access usage data and the application data.

5. The computer-implemented method of claim 4, wherein said mapping the entitlements to the performed actions is performed by solving a linear program in binary variables.

6. The computer-implemented method of claim 4 further comprising receiving attribute data comprising user IDs and respective human resources and business attributes.

7. The computer-implemented method of claim 6, further comprising mapping the account IDs to the user IDs.

8. The computer-implemented method of claim 7, wherein said generating the plurality of groups of actions is performed using further the attribute data.

9. The computer-implemented method of claim 8, wherein said generating the plurality of groups of actions is performed using at least one of a clustering method, a matrix decomposition method, a topic modeling method, a coverage maximization method and an association rule mining method to obtain a probabilistic assignment of actions to the groups of actions.

10. (canceled)

11. (canceled)

12. (canceled)

13. (canceled)

14. (canceled)

15. The computer-implemented method of claim 9, further comprising.
using a discretization procedure to convert the probabilistic assignment of actions to the groups of actions to an actual assignment of actions to the groups of actions; and
assigning at least one of the respective human resources and business attributes to each one of the groups of actions, thereby obtaining an assignment of attributes for each group of actions.

16. (canceled)

17. (canceled)

18. (canceled)

19. (canceled)

20. A system comprising
a group generating unit for receiving access usage data comprising identities and respective performed actions, and generating a plurality of groups of actions by regrouping given ones of the identities having associated thereto a same group of the respective performed actions using the access usage data; and
a role generating unit for:
receiving a list of entitlements each allowing the execution of at least one respective action,
for each one of the plurality of groups of actions, determining a group of entitlements contained in the list of entitlements that allow the execution of the group of actions;
for each one of the plurality of groups of actions, associating thereto the respective group of entitlements, thereby obtaining a plurality of roles; and
outputting the plurality of roles.

21. The system of claim 20, wherein the access usage data comprises account identifications (IDs) and the respective performed actions;

22. The system of claim 21, wherein at least one of the group generating unit and the role generating unit is further configured for receiving application data comprising respective actual entitlements associated with the account IDs.

23. The system of claim 22, wherein the role generating unit is further configured for generating a map of entitlements by mapping the entitlements to the performed actions using the access usage data and the application data.

24. The system of claim 23, wherein the role generating unit is configured for mapping the entitlements to the performed actions by solving a linear program in binary variables.

25. The system of claim 23, wherein at least one of the group generating unit and the role generating unit is further configured for receiving attribute data comprising user IDs and respective human resources and business attributes.

26. The system of claim 25, wherein at least one of the group generating unit and the role generating unit is further configured mapping the account IDs to the user IDs.

27. The system of claim 26, wherein the group generating unit is configured for generating the plurality of groups of actions further using the attribute data.

28. The system of claim 27, wherein the group generating unit is configured for generating the plurality of groups of actions using at least one of a clustering method, a matrix decomposition method, a topic modeling method, a coverage maximization method and an association rule mining method to obtain a probabilistic assignment of actions to the groups of actions.

29. (canceled)

30. (canceled)

31. (canceled)

32. (canceled)

33. (canceled)

34. The system of claim 28, wherein the group generating unit is further configured for:
using a discretization procedure to convert the probabilistic assignment of actions to the groups of actions to an actual assignment of actions to the groups of actions; and
assigning at least one of the respective human resources and business attributes to each one of the groups of actions, thereby obtaining an assignment of attributes for each group of actions.

35. (canceled)

36. (canceled)
